(19) United States
(12) Patent Application Publication
(10) Pub. No.: US 2003/0070648 A1
(43) Pub. Date: Apr. 17, 2003

(54) High torque power engine that transmits motion between a piston and power shaft through a 1-way clutch

(76) Inventor: Robert Louis Giuliani, Honolulu, HI (US)

Correspondence Address: R.L. GIULIANI, 1456 Thurston Ave. A-1204, Honolulu, HI, 96822, US

(21) Appl. No.: 10/252,927

(22) Filed: Sep. 24, 2002

Related U.S. Application Data
(60) Provisional application No. 60/329,617, filed on Oct. 17, 2001.

(51) Int. Cl. F02B 75/32

(52) U.S. Cl. 123/197.1

(57) ABSTRACT

This is a high torque power reciprocating engine. Comprehensive mathematics shows its fuel efficiency and why it is inherently impossible to make crank engines efficient.

The crankshaft is replaced by a straight shaft and a 1-way clutch. The 1-way clutch transmits motion between power pistons and the shaft. Pistons are motionless in deactivated cylinders because of the 1-way clutch's overrun feature. The clutch's constant length radius provides instant peak torque at the beginning of the power stroke. The described 1-way clutch is preferred because of its ruggedness, efficiency and long life. Motion is transmitted between its races perpendicular to clutch radials. Transmitting members can be hydraulic or mechanical and encased in cartridges. They are easily replaceable without clutch disassembly. But its breakaway design allows easy disassembly and assembly if necessary.

The length of the piston's stroke is not mechanically limited, which allows a longer piston stroke and for sizing the cylinder for the burn characteristics of the fuel. Pistons operate synchronously in pairs. Two computer controlled pairs (four cylinders) allow 50% power stroke overlap, which gives smooth shaft rotation. A greater number of pairs increase the overlap.

A version includes a reduced cylinder head volume that provides a higher compression ratio than its circumscribing cylinder for better ignition. The cylinder's volume is instantly increased after ignition, which reduces the compression ratio to the best thermal efficiency and greatly reduces waste heat and exhaust pollution.

The 1-way clutch's overrun feature combines with an energy storage device to capture, store and dump regenerated energy on demand.

There are other desirable features to this engine e.g., it will be smaller than comparable powered crank engines. Other versions are disclosed.

### CROSS-REFERENCE TO RELATED APPLICATIONS

This application claims the benefit of the U.S. provisional application No. 60/329,617 filed on Oct. 17, 2001.

### FEDERALLY SPONSORED RESEARCH OR DEVELOPMENT

Not applicable

### BACKGROUND OF THE INVENTION

Enormous funds and research have been poured into fuel cell, electric vehicles and crank engine hybrids for years in an unsuccessful effort to replace the ubiquitous crank engine.

The crank engine is very inefficient because the two angles at both ends of the connecting rod of length L and the crank angle α (FIG. 16) combine to slow the piston's speed, which traps the very rapidly expanding combustion gases in a small chamber. The gases build up very high heat and pressure at and near tdc. Here, nearly all the force from the pressure is vectored against the crankshaft's bearings instead of rotating it. Inertia is combined with extra fuel on each power stroke to overcome the angles' resistance. The result is excess exhaust pollution and waste heat. The waste heat is lost and the pollutants are partly scrubbed from the exhaust when it is too late.

The pollution and the waste heat must be reduced in the combustion chamber by converting them to mechanical motion with a more complete burn. To do that, all the rod and crank angles must be zero during the entire power stroke but that is impossible in a crank engine. The following mathematics explains why:

FIG. 16 is a schematic that represents a crank engine. FV1, FV2, FV3 are force vectors that come from burn pressure driving the piston 38. FV1 is always along a radial of the crankshaft axis C. Only FV3, being tangent to the crank circle d, rotates the shaft where FV3=FV1(Cos θ)(Cos Φ). The crank engine's efficiency is zero at tdc when angle θ=0° but angle Φ=90°, making FV3=FV1(1)(0)=0. When FV2 is tangent to circle d, Cos Φ=1.0 and Tan θ=r/L. θ=Tan⁻¹r/L from which Cos θ is found. The efficiency at that point is FV3/FV1=Cos θ. The importance of angle θ=Tan⁻¹r/L will be shown below.

The ratio of the displacement M along the crank circle d to the piston's displacement a at any chosen crank angle α is easily found from FIG. 16. r is the crank arm length and α is in degrees.

r=b+a

a=r(1−Cos α)

M=παr/180

M/a=πα/[180(1−Cos α)]

For instance when α=10°, M/a=11.49:1. The rod's slow crank end must go 11.49 times as far as the piston. The slower the crank's rotation, the longer the gases are trapped in a small chamber and the lower the engine's efficiency. It is known that this is where most of the pollution and waste heat are created by the confined hot, pressurized gases. The crank's angular efficiency equation:

Cos θ=FV2/FV1

Cos Φ=FV3/FV2

FV2=FV1(Cos θ)

FV2=FV3/Cos Φ

FV3=FV1(Cos θ)(Cos Φ)

FV3/FV1=(Cos θ)(Cos Φ)

Crank engine's angular efficiency. It caps and greatly reduces the burn efficiency.

FIG. 16 is also the basis for the following indented equations that lead to the Cos θ and Cos Φ equations in terms of crank angle α, length L and crank arm r:

180−β=γ

γ+θ+Φ=180

β=90−α Note the rt. triangle (α+β+90)

180−(90−α)=γ or 90+α=γ

(90+α)+θ+Φ=180

α+θ+Φ=90

n−r Sin α

Sin θ=(r/L)Sin α

θ=Sin⁻¹[(r/L)Sin α]

Cos θ=Cos{Sin⁻¹[(r/L)Sin α]}

α+Sin⁻¹[(r/L)Sin α]+Φ=90

Φ=90−{α+Sin⁻¹[(r/L)Sin α]}

Cos Φ=Cos(90−{α+Sin⁻¹[(r/L)Sin α]})

The equations Cos θ, Cos Φ are easily solved with a hand calculator. For instance, they give the angular efficiency=22.4% when α=10°; r=1.5″; L=5.0″. Since the burn efficiency is low (See M/a above) the total efficiency has to be much less than 22.4% in this example. The efficiency increases as α increases but the combustion pressure decreases as a increases. A higher rpm increases efficiency but that has reached its limit and it is not good enough.

The importance of angle θ=Tan⁻¹r/L now follows. That is when FV2 is tangent to the circle d at the arm r which makes angle Φ=0.0 and Cos Φ=1.0. The angular efficiency is Cos θ=Cos(Tan⁻¹r/L). In the example above where r=1.5″; L=5.0″; FV3/FV1=Cos θ=95.8%. Extend L relative to r so that angle θ goes to 0.0. Then

$${Lim Cos }_{θ \to 0.0} θ = 1.0 .$$

θ=1.0. (This is the foundation for differential calculus). That makes the angular efficiency FV3/FV1=(Cos θ)(Cos Φ)=(1)(1)=100% because there is no angular resistance since the angles θ,Φ disappear. The variable angle α disappears. The crank arm r disappears. The variable length torque arm n (FIG. 16) which requires torque buildup is replaced by the fixed length torque arm r′ (FIG. 17) which gives instant peak torque.

Unlike the crank, FV1 in this invention (FIG. 17) is always directed to rotating the output shaft 8 rather than directed against the shaft's bearings. FV1 is transmitted with both angles θ,Φ=0.0 through the entire power stroke. The M/a=1:1 through the entire stroke. The circumference d′ replaces the crank circle d in FIG. 16. Motion is transmitted through the fixed length torque arm r′ to the output shaft 8.

### BRIEF SUMMARY OF THE INVENTION

This invention is a reciprocating engine that uses a 1-way clutch to transmit motion between the power piston and the output shaft. A preferred 1-way clutch for this engine is described below Though conventional 1-way clutches will work, they are expensive to repair and too fragile for long life. They also transmit motion between the races through two vectors. One vector is parallel to the clutch radial, which does not transmit motion. Instead, its energy is converted to waste heat that can cause early clutch failure. The preferred 1-way clutch in my invention (FIGS. 9-15) efficiently transmits motion between the races perpendicular to the clutch radials.

The crankshaft is discarded and replaced with a straight shaft. The piston is offset from the shaft's axis by the radius of the 1-way clutch. The combustion pressure and radius of the 1-way clutch are selected to fit the burn characteristics of the fuel, which controls the piston's motion and length of the piston's stroke. There is no mechanical limit to the piston's stroke. A longer stroke permits a large part of the compression stroke to be used for exhaust. Unlike the crank engine, the power shaft does not control these parameters. The crankshaft hides problems that cause its engine to be inefficient. This invention exposes them as opportunities for a greater engineering skill to design a better, more fuel efficient engine.

Cylinders are in pairs. Computer controlled ignition is an object that enables power stroke overlap with two or more pairs. Other objects of this invention include:

1. fuel efficiency;

2. instant peak torque at the beginning of the power stroke;

3. capture and store regenerated energy then dump it on demand to the output shaft;

4. deactivate pairs of pistons without load on the output shaft due to the 1-way clutch overrun feature;

5. reduced mass engine compared to a crank engine;

6. provide a breakaway 1-way clutch that is easily disassembled and reassembled for repairs;

7. a 1-way clutch that transmits motion between its races perpendicular to clutch radials.

### BRIEF DESCRIPTION OF THE DRAWINGS

In the drawings: FIGS. 2,3,7 show a representative 1-way clutch of any suitable design but a preferred rugged design in which motion is transmitted between races perpendicular to clutch radials is described with reference to FIGS. 9-15. Number 89 refers to a cover plate in FIGS. 9,12,15 and to a cover plate with cartridge, including its elements in FIGS. 9,10. The outer race is referred to by its separate parts 5A, 5B and 5C in FIGS. 9,10 and as a whole by the number 5 in the other FIGs. No. 82 and No. 96 in FIGS. 9,10 refer to equivalent parts. The output shaft is represented by its axis 91 in FIG. 10. Parts are shown with solid lines in drive and dashed lines in overrun.

FIGS. 6-8 show possible enhancements to the basic invention, which is to efficiently transmit power between a power piston and an output shaft through a 1-way clutch.

FIG. 1 is a side view showing how movement of parts is synchronized between two cylinders in a pair.

FIG. 2 is taken essentially along line A-A in FIG. 1 to show how motion is transmitted between a piston and a 1-way clutch through a gear mesh,

FIG. 3 shows how a belt or a chain replaces the gear mesh in FIG. 2.

FIG. 4 shows a means for decelerating and reversing pistons at the end of the stroke.

FIG. 5 shows two computer-controlled pairs of cylinders combined with an energy storage device.

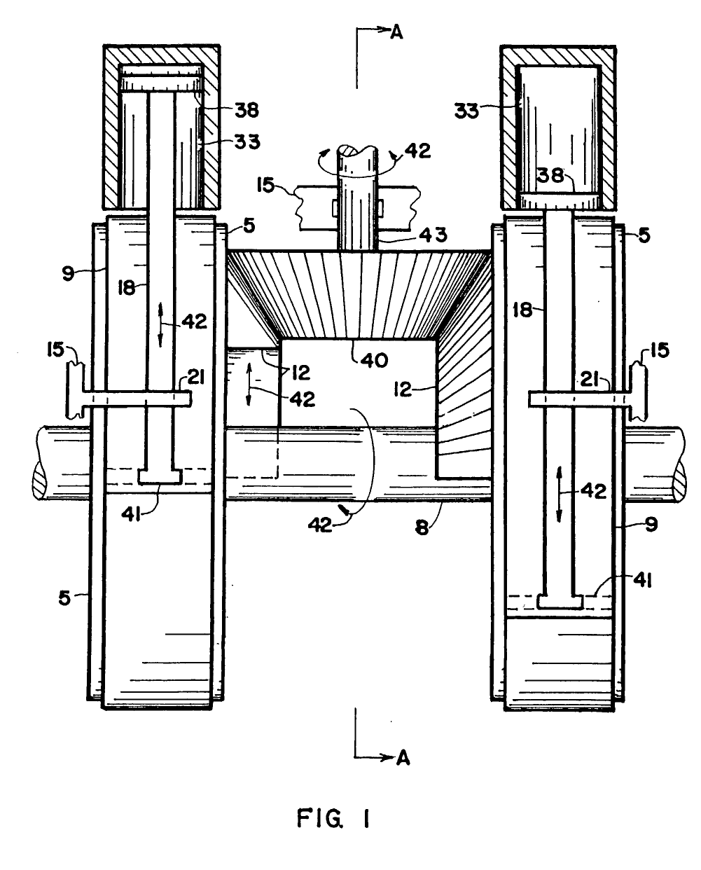

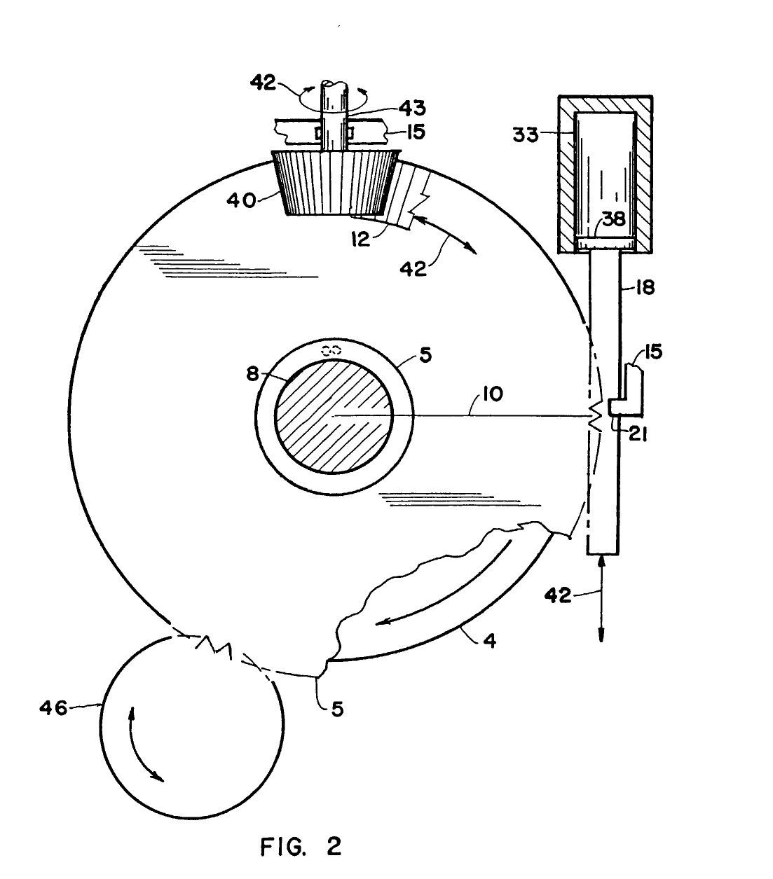

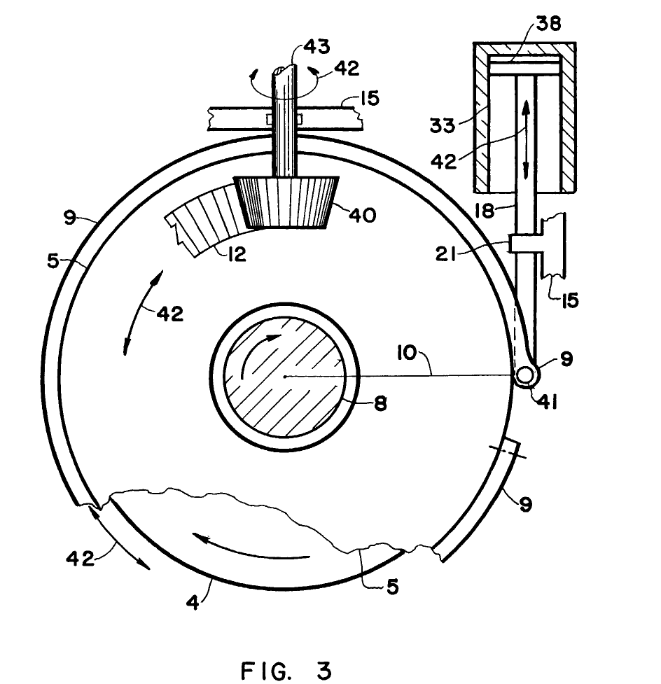

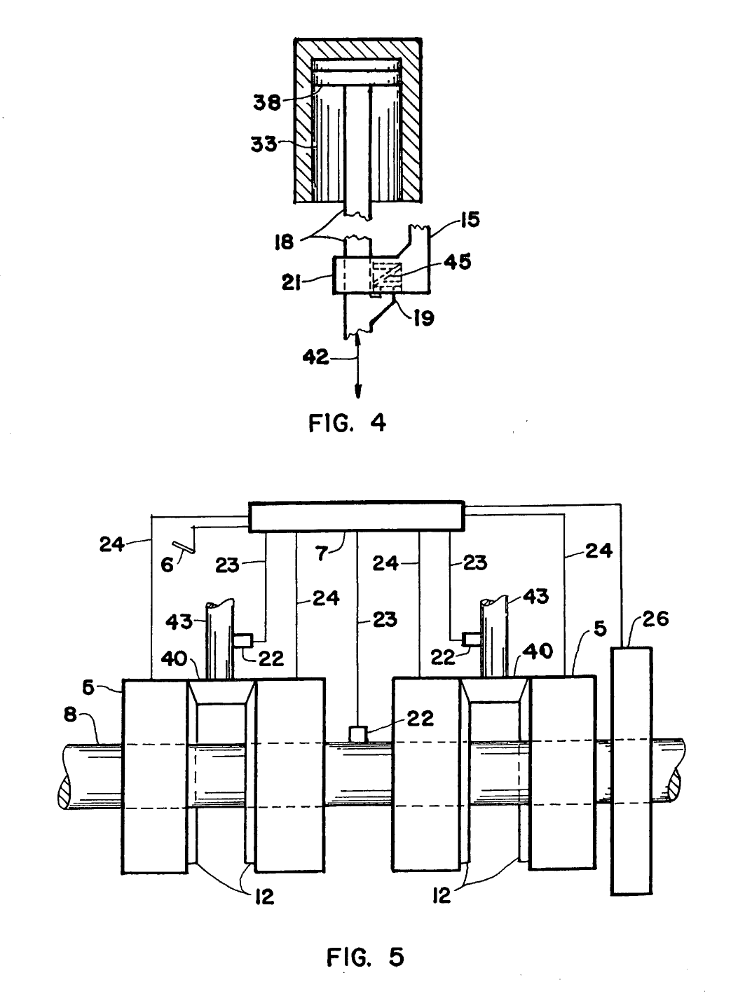

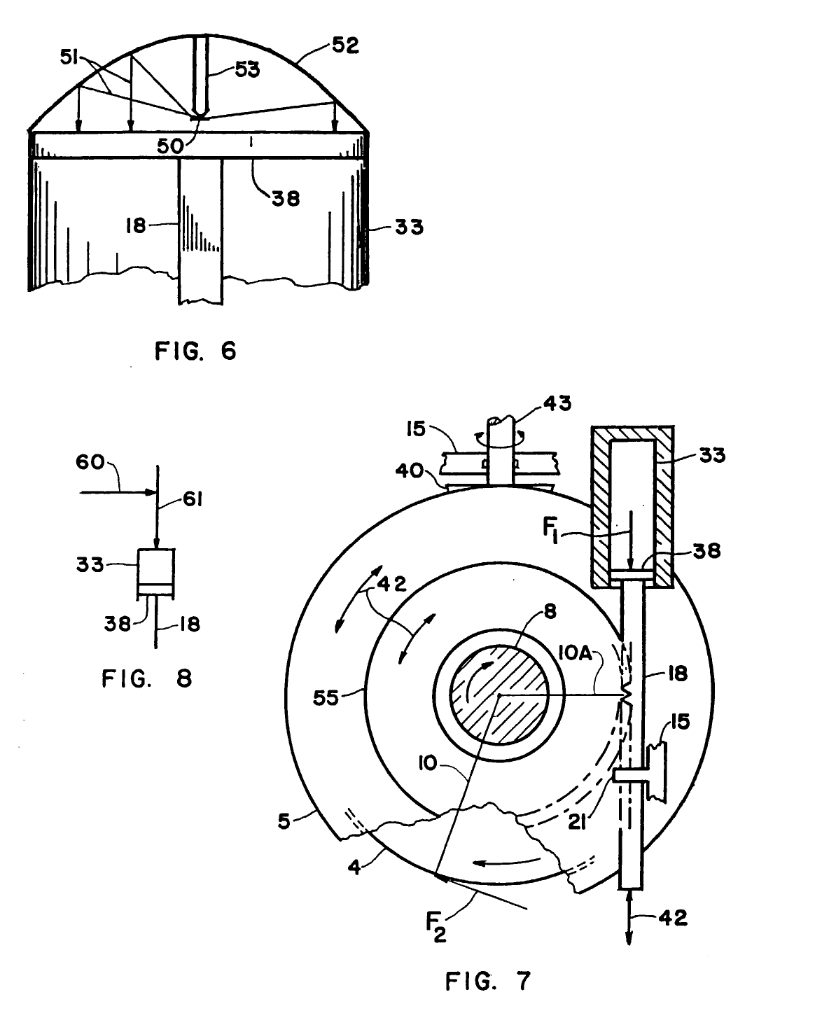

FIG. 6 shows a parabolic cylinder head.

FIG. 7 shows a means to increase combustion pressure.

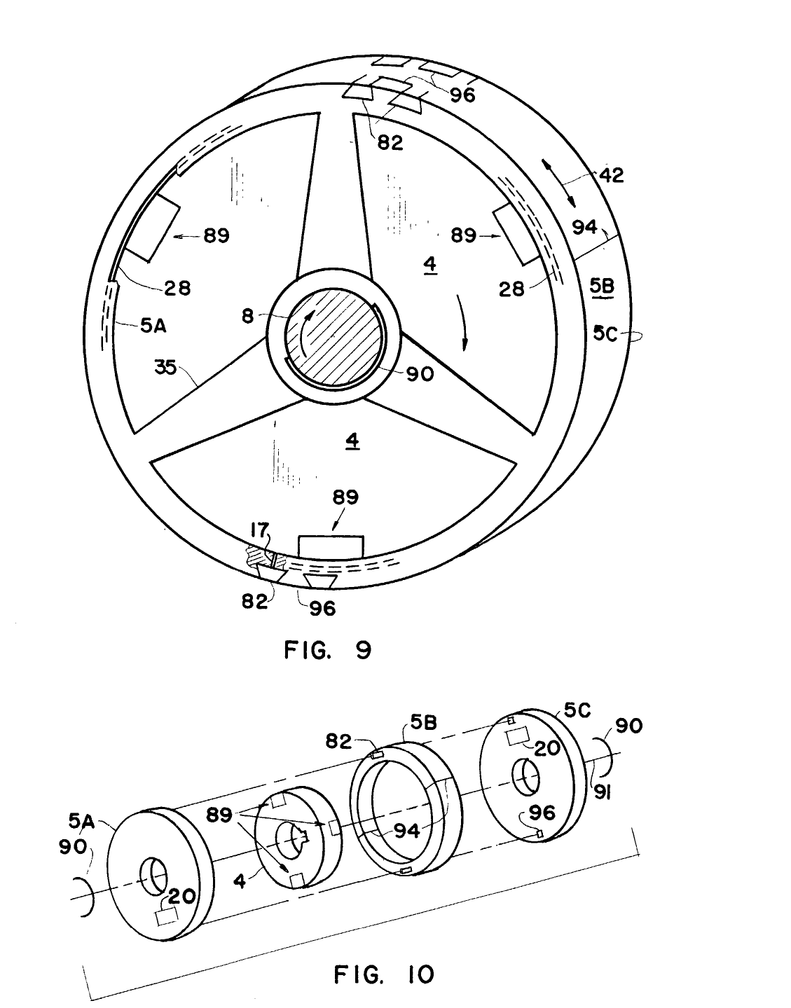

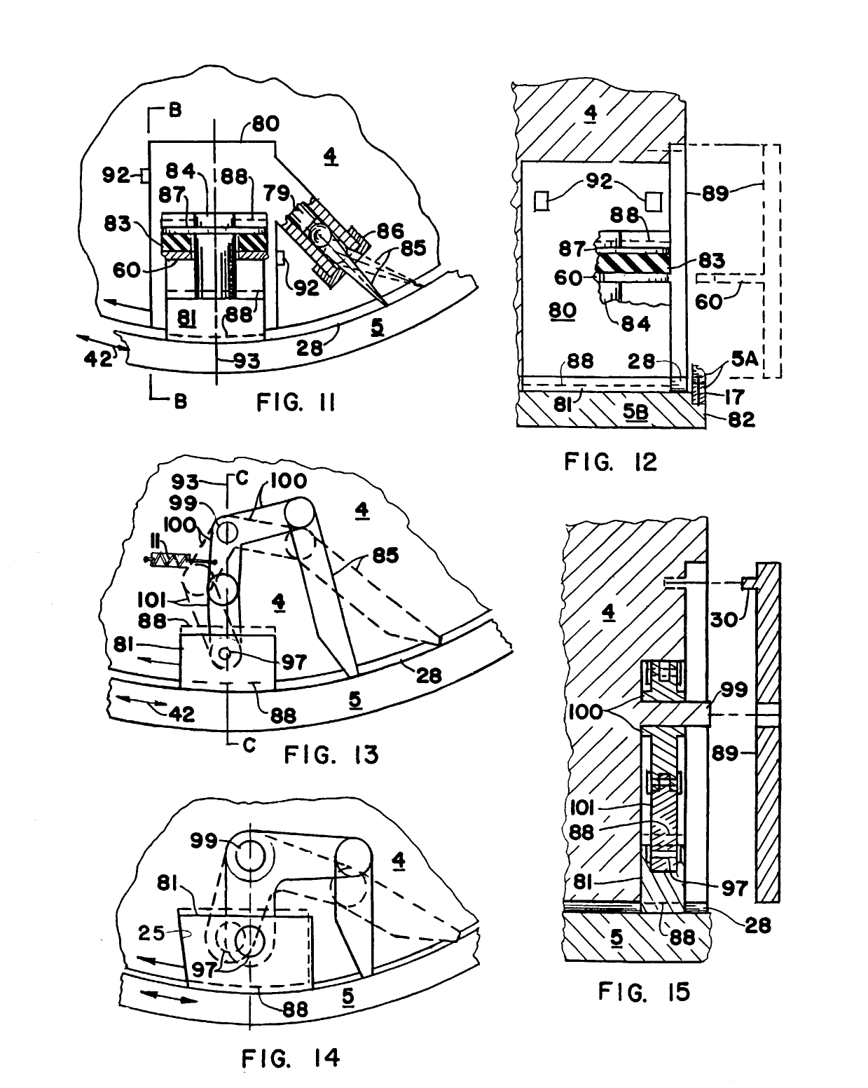

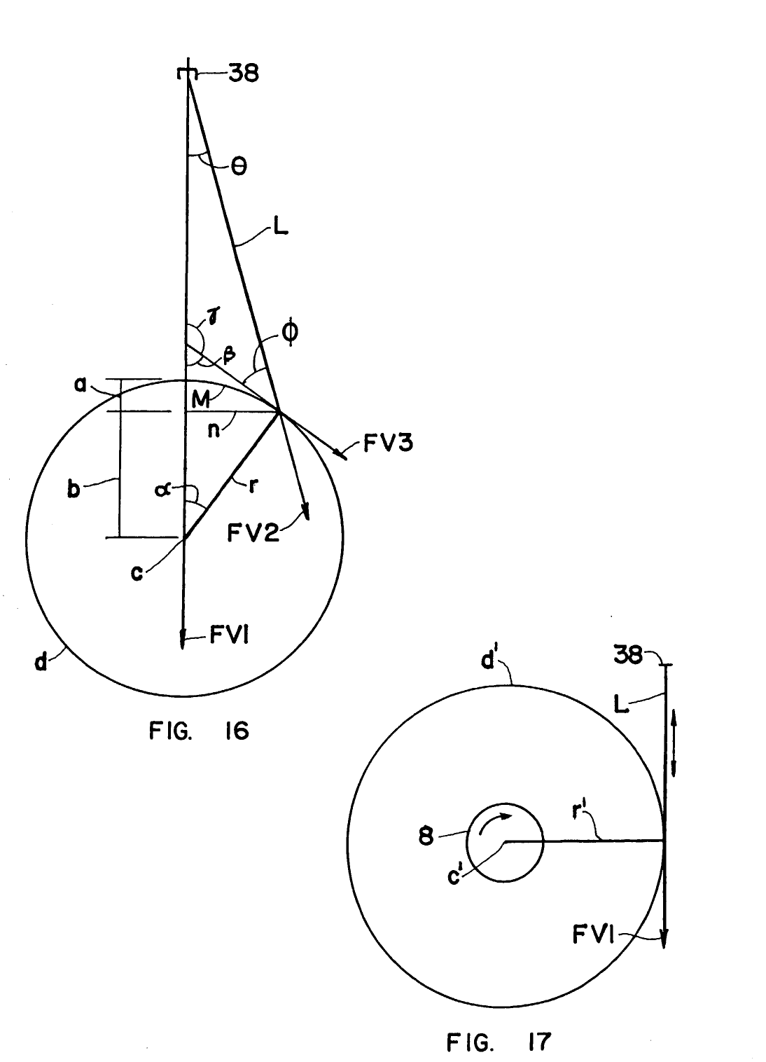

FIG. 8 shows water mist injection into the air stream.

FIG. 9 shows an oblique view of the 1-way clutch with keystone shaped interlocking teeth on the outer race.

FIG. 10 is an exploded view of the several parts of a clutch aligned along a shaft axis. Alternatively, pegs with matching holes replace the teeth in FIG. 9.

FIG. 11 is a front view of a replaceable clutch cartridge with its cover plate removed and casing broken away to show the internal elements of a hydraulic motion transmitting member.

FIG. 12 is a cross sectional along B-B in FIG. 11.

FIG. 13 is one embodiment of a mechanical transmitting member.

FIG. 14 is a second mechanical embodiment of a transmitting member

FIG. 15 shows a cross sectional along C-C in FIG. 13.

FIG. 16 is a schematic of a crank engine used for mathematical reference in the text above.

FIG. 17 is a schematic of this invention used to mathematically compare with FIG. 16.

### DETAILED DESCRIPTION OF TUE INVENTION

This is a two-stroke reciprocating engine. Cylinders 33 and their related parts come in pairs as shown in FIG. 1. During operation, certain parts reciprocate as shown by arrows 42. The reciprocating parts that are not shown with arrows 42 are presumed to be obvious. The pistons 38 function in pairs where each piston in the pair effects synchronized motion in the other piston through an idler 40. The idler is part of shaft 43 that is carried by the housing 15.

The idler 40 meshes with two sector gears 12 (FIGS. 1-3), each carried by the outer race 5 of a 1-way clutch. The sector gears mesh with opposite sides of the idler 40 so that, as the first piston 38 in a pair is on the power stroke, the idler causes the second piston in the pair to advance on its exhaust and compression stroke synchronized with the first. Power stroke overlap with two or more pairs will be described later with reference to FIG. 5.

FIG. 2 shows a gear mesh between rod 18 and the outer race 5 to transmit motion. The motion then goes to the inner race 4 of the clutch and then to the output shaft 8. Rod 18 reciprocates along a straight path 42. FIG. 2 also shows a reciprocating starter 46 gear meshed with the outer race 5. By shifting race 5, the starter shifts both pistons 38 until ignition. Alternatively, shaft 43 can be used to shift the pistons until ignition.

The fixed length torque arm 10 causes instant peak torque at the beginning of the power stroke. A guide 21, secured to housing 15, eliminates side thrust and keeps the pistons 38 square in their cylinders. See FIGS. 1-3. Wrist pins and piston skirts are not needed. Cylinder wear is minimized. In FIG. 1 and FIG. 3, a belt or a chain 9 is fastened to the outer race 5. The way it is wrapped around race 5 always keeps it taut, which prevents backlash. It is wrapped far enough to prevent slippage as the member 9 rotates the race 5 in response to the power stroke. Rod 18 is connected to one end of the member 9 with a suitable fastener 41.

The 1-way clutch's override feature in this engine allows output shaft 8 and the clutch's inner race 4 to rotate independently of the pistons 38. When the inner race's speed is greater than the outer race 5 speed, free regenerated energy is collected for storage in an energy storage device 26 (FIG. 5) available for dumping to shaft 8 on demand.

The guide 21 is combined with a decelerator mechanism (FIG. 4) to stop piston 38 at the end of its compression stroke. The decelerator includes a bumper 19 that is part of each rod 18 in a pair and a spring 45 for each bumper. The spring is encased in the guide 21. An opening in the housing 15 allows easy replacement of the spring. The spring absorbs the impact of bumper 19 to halt the motion of piston 38, which is then accelerated on its power stroke by timely expanding combustion gases. The impact is reduced because bumper 19 is decelerating due to the power loss of the second piston to the shaft 8 through the 1-way clutch. The decelerator is positioned to prevent backlash of the gears 12 (FIG. 1) that mesh with idler 40.

A computer 7 (FIG. 5) monitors input from the throttle 6 and the sensor 22 on output shaft 8 through leads 23 to determine the size of the combustion charge to transmit to the cylinders through injector lines 24. The position of piston 38 is monitored through sensors 22 on shaft 43 and used for ignition timing. By monitoring the motion of each shaft 43 in several pairs, the computer controls timing between the pairs. Since the pistons are not tied to the output shaft 8, the computer begins a power stroke in one pair when a piston in another pair is partly through its power stroke. 50% power stroke overlap and smooth rotation of the output shaft 8 is obtained with two pairs (four cylinders). Greater overlap is gained with more pairs.

Reduced Ignition Volume Embodiment.

In this version, the volume under the cylinder head is less than its circumscribing cylinder, which allows a higher ignition compression ratio. The piston's motion is unhindered by the angles θ,Φ (FIG. 16) allowing the rapidly expanding gases to instantly gain cylinder volume where the initial ignition pressure is reduced to the fuel's best bum pressure.

Example: The volume of a parabolic reflector is 21 the volume of its circumscribing cylinder, which makes the compression ratio twice as high there. For spark ignition, FIG. 6 shows a cylinder head 52 with an igniter 50 at its focus at the end of a replaceable plug 53. An energy wave 51 expands essentially hemispherically to hit the parabolic reflector. The reflector directs the wave to impact the piston uniformly, which gives a boost to both pistons in a pair as they simultaneously reverse.

A hemispherical head has a volume ⅔ its circumscribing cylinder giving a 1½ compression ratio.

Hydrogen Enhanced Ignition.

In another version (not shown), the storage device 26 (FIG. 5) includes a hydrogen (H₂) storage tank or a means to convert electricity to H₂. In some applications, considerable excess regenerated energy at shaft 8 is anticipated from the 1-way clutch's overrun feature that can be used to drive a generator to provide electricity. The H₂ is transmitted to the combustion chambers 33 to saturate the ignition of the regular fuel. Pure H₂ is not needed.

Hydrogen's flame speed in an H₂ rich mixture is about 6 times faster than gasoline. (Energy Technology HDBK, pp. 4-39 to 4-43, Considine, 1977). It has a hot temperature and low energy density by volume to act as a saturating igniter of the regular fuel for a more complete burn. A fast, more complete burn is preferred since M/a=1:1. (See M/a above) and the angles θ,Φ (FIG. 16) do not exist.

Water Mist Injection.

Another version of this engine (FIG. 8) includes a controlled injection of water mist 60 into the air stream 61 to humidify the air leading to the combustion chamber 33, which enhances the engine's operation. The mist also noticeably improved my crank engine's operation despite the high M/a ratio (above) See FIG. 16.

AlternativeClutch Design.

In FIGS. 1-3, the rod 18 engages the outer race 5 tangent to its rim. If arm 10 cannot be reduced enough to satisfy the preferred clutch's mechanism (FIGS. 9-15), an extension 55 of its race 5 along shaft 8 has a shorter arm 10A, which is the extension's radius. See FIG. 7. The rod 18 engages the extension's rim at the shorter arm 10A rather than the race 5 rim. Rod 18 reciprocates along its straight path 42, tangent to the extension's rin. Motion from combustion pressure F₁ is transmitted to the race 5 extension through the gear mesh. Race 5 transmits the motion from pressure F₂ to the inner race 4 at the longer radius 10.

Preferred 1-Way Clutch Embodiment.

The preferred breakaway 1-way clutch is shown in FIGS. 9-15. Its outer race 5 drives clockwise in its indexing motion 42 (FIGS. 2,3). The outer race 5 has three separate parts: sides 5A, 5C and race 5B. The gap 28 is narrow and near the race 5B to reduce stress on the parts. Race SB is the outer rim of the gap. FIG. 9 shows the motion transmitting members 89 in relation to the gap.

The inner race 4 is keyed to power shaft 8. A snap ring 90 to shaft 8 on each side of the race 5 (FIG. 10) keeps the clutch from shifting along the axis 91 of shaft 8. The snap rings also prevent separation of the three outer race parts. In extreme or unusual use, a dowel 17 (FIGS. 9,12) reinforces the snap rings to keep the parts together. It extends through race 5A and 5C to contact a keystone shaped tooth 82 (or an equivalent peg 82 in FIG. 10) on each side of race 5B. It is easily displaced for breakaway to replace race 5B.

FIGS. 9,10 show two halves of race 5B that are kept in contact 94 by the teeth (or pegs). When race 5B is separated from sides 5A and 5C, the halves fall apart for replacement without separating the other parts from shaft 8.

Bearings in FIG. 9 are between the outer race 5 and the shaft 8. Spokes 35 in side 5A and side 5C reduce material cost and reduce indexing inertia. The transmitting members 89 are easily replaceable when positioned between the spokes or behind an aperture 20 (FIG. 10) in the sides 5A and 5C.

Move the bearings to the conventional position at gap 28 and the dowel (FIG. 12) can keep the parts together without the spokes 35.

The keystone shaped teeth 82 (FIG. 9) extend from race 5B and make a strong interlocking fit with keystone shaped teeth 96 on the sides 5A and 5C. The fit ties the parts together radially and circumferentially but allows them to be easily moved axially for disassembly by removing the snap rings 90. The FIG. 10 version uses equivalent pegs 82 that fit into holes 96 in sides 5A and 5C. There are as many teeth (or pegs) as needed.

The cover plate 89 (FIGS. 12,15) is designed to guide the moving parts during their movements.

Hydraulic Embodiment of the 1-Way Clutch.

Replaceable hydraulic cartridges 89 (FIGS. 9,10) are carried by race 4. The race is molded to rigidly hold the cartridge casing 80 (FIGS. 11,12). Pegs 92 slide into grooves in the race 4 to reinforce the cartridge against movement, especially toward race 5 under centrifugal force. A piston 81, shown in driving contact with race 5, moves a short distance 88 along the clutch radial 93 while in sliding contact with the casing 80 and the casing is in contact with the race 4. The piston is secured to a piston rod 84 that is hydraulically actuated from a reservoir section of the casing from which it extends. Motion between race 5 and race 4 is transmitted through the piston perpendicular to radial 93 that extends from the axis 91 (FIG. 10) of shaft 8. The casing 80 has an arm that holds a plunger 79 in contact with the ball end of a trigger 85. A cap 86 having a slot aligned with the trigger's motion is immovably secured to the arm. The trigger extends through the slot to contact the race 5. A resilient piece inside the cap between it and the ball end is preferred. The angle between the arm and the radial is small enough to prevent jamming between the arm and the trigger.

As the trigger 85 shifts from its overrun position to the drive position, it pushes the plunger 79 farther into its arm to displace hydraulic fluid in the reservoir contained in the casing 80. The fluid displaces the piston rod 84 to drive the piston 81 into non-slip contact with race 5. The piston is in contact with race 4 and drive is transmitted from the race 5 through the piston to race 4 perpendicular to a clutch radial. The contact surfaces of the piston and race 5 may have matching grooves to increase friction. The trigger's motion is unhindered as it moves the piston from the overrun position 88 to contact the race 5, except for compressing a resilient element 83 (FIGS. 11,12).

The two-part resilient element 83 fits around the rod 84 for easy replacement. The element is positioned between a plate 87 that is part of the rod and a two-part, immovable second plate 60 that is part of the casing 80 and cover plate 89. When the trigger shifts to its drive position, the element is compressed between the two plates as the hydraulic fluid drives the rod 84 to bring the piston and race 5 into non-slip contact. The element expands against the immovable plate 60 to shift the piston to its overrun position 88 when the trigger shifts to its overrun position and releases the fluid pressure.

Mechanical Embodiments of the 1-Way Clutch.

Two of at least three mechanical versions of the transmitting members are shown in FIGS. 13,14. A casing for them is omitted to show a cost saving but can be included. The cover plate 89 and race 4 substitute for the casing 80. Without a casing, the piston 81 is always in direct, sliding contact with race 4 as it reciprocates along the radial 93 that extends from the clutch axis 91 (FIG. 10). Like the hydraulic version, the short reciprocal motion goes between contact with the race 5 and position 88. Drive is transmitted perpendicular to the radial 93 from race 5 through the piston to race 4.

FIG. 13 shows the piston connected to a piston rod O1 by a wrist pin 97. The rod is connected to a lever 100 which, in turn, is connected to the trigger 85. All the connections are hinged to allow pivoting. The lever's fulcrum 99 extends from race 4. A cantilevered fulcrum (not shown) uses a snap ring or common washer and cotter pin to retain the lever. But a stronger fulcrum fits into a hole in the plate 89 (FIG. 15) which is preferred for heavy duty. Three pegs 30, placed at the apexes of a broad triangle on plate 89, rigidly fix the plate to the race 4 in all embodiments. The angle between the lever 100 and the trigger 85 equals or is very close to 90° in the drive position to reduce stress on the trigger and its connection with the lever. The angle between the rod 101 and lever is preferably not straight when the piston contacts race 5. After contact, the angle straightens to increase pressure between the piston, the race 5 and lever's fulcrum 99 with limited force upon the trigger. A spring 11 insures instant separation of the piston 81 from race 5 as overrun begins.

The second mechanical version is shown in FIG. 14. Some reference numbers for the same parts in FIG. 13 are omitted in FIG. 14 to avoid overcrowding. In FIG. 14, the rod 101 is discarded by connecting one arm of the lever 100 directly to the wrist pin 97. A slant 25 of the contact surfaces is provided between the piston 81 and race 4. The spring 11 in FIG. 13 can be included.

Not shown is a third mechanical version that sets the piston on one radial of the clutch and the fulcrum on another. It can also eliminate the rod 101.

In all the 1-way clutch embodiments: (1) the angle at the trigger's two extreme positions must not cause jamming, (2) the trigger should be coated with a suitable ceramic and shaped to reduce drag but instantly grabbing the outer race when reversing to the drive direction and (3) the piston's motion 88 goes only far enough to provide clearance between the piston and the outer race during overrun.

I claim:

1. An engine, the combination comprising;
a shaft;
a power element; and
a 1-way clutch wherein the power is transmitted between the element and the shaft through the 1-way clutch.

2. The combination of claim 1 which includes a reciprocating means.

3. The combination of claim 2 which includes;
a second 1-way clutch;
a second power element; and
the means includes an idler communicating the clutches.

4. The combination of claim 3 which includes more than one of the combinations disposed along the length of the shaft.

5. The combination of claim 4 which includes a computer.

6. The combination of claim 1 which includes a belt or a chain or a gear mesh connecting the element and the 1-way clutch wherein the power is transmitted therebetween.

7. The combination of claim 1 which includes;
an energy storage means wherein the storage means communicates with the shaft for capturing, storing and dumping regenerated energy therebetween.

8. The combination of claim 1 which includes;
an energy storage means;
a combustion charge; and
the storage means includes a hydrogen tank or generating apparatus wherein hydrogen is transmitted to the combustion charge.

9. The combination of claim 1 which includes;
a combustion charge; and
the combustion charge comprises a water mist.

10. The combination of claim 1 which includes;
an ignition chamber; and
the chamber comprises a smaller volume than its circumscribing cylinder.

11. The combination of claim 10 in which the chamber includes a parabolic reflector.

12. The combination of claim 1 in which the 1-way clutch includes a transmitting member wherein the member transmits the power between an inner race and an outer race essentially perpendicular to a radial of the 1-way clutch.

13. The combination of claim 12 in which the member includes hydraulic or mechanical embodiments.

14. The combination of claim 1 in which the 1-way clutch includes a breakaway embodiment.

15. The combination of claim 1 in which the 1-way clutch includes a dowel.

16. The combination of claim 1 in which the 1-way clutch comprises;
a first radius;
a second radius; and
the first radius is shorter than the second radius.
